(19) United States
(12) Patent Application Publication
(10) Pub. No.: US 2022/0292518 A1
(43) Pub. Date: Sep. 15, 2022

(54) SENTIMENT ANALYSIS DATA RETRIEVAL

(71) Applicant: Wells Fargo Bank, N.A., San Francisco, CA (US)

(72) Inventors: Meltem Kilicoglu, New York, NY (US); Muhammad Farukh Munir, Pittsburg, CA (US); Brian M. Pearce, Pleasanton, CA (US); Wairnola Marria Rhodriquez, San Francisco, CA (US); Senthil K. Subramaniam, San Ramon, CA (US); Inna Treyger, San Francisco, CA (US)

(21) Appl. No.: 15/923,797

(22) Filed: Mar. 16, 2018

(51) Int. Cl. G06Q 30/00

(52) U.S. Cl. CPC G06Q 30/01

(57) ABSTRACT

Various examples described herein are directed to systems and methods for sentiment data retrieval. A customer is recognized and customer data associated with the customer is retrieved based on the recognizing the customer. A relationship with the customer is determined based on the customer data. Input data associated with the customer is received from an input device. A sentiment analysis is run on the input data. A customer need based on the sentiment analysis, the customer data, and the determined relationship is determined. Customer data associated with the customer need is retrieved and provided.

### BACKGROUND

Data associated with a customer continues to grow. Data can be generated from customer accounts, transactions, purchases, etc. As the amount of data grows, using relevant and timely data for a customer becomes difficult. Using the customer data in an effective way can be difficult. In addition, data may include real-time data such as image data, voice data, location, etc. While the data may be used to draw a conclusion that is used to help the customer, determining this conclusion and providing relevant information to the customer or an employee that may help the customer is elusive.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not of limitation, in the figures of the accompanying drawings, in which:

FIG. 1 is a block diagram showing a sentiment data retrieval according to some embodiments.

FIG. 2 is a flow diagram showing a process for retrieving data based on sentimental analysis according to some embodiments.

FIG. 3 is a block diagram showing one example of a software architecture for a computing device.

FIG. 4 is a block diagram illustrating a computing device hardware architecture, within which a set or sequence of instructions can be executed to cause the hardware to perform examples of any one of the methodologies discussed herein.

### DETAILED DESCRIPTION

Effectively using data related to a customer combined with sentiment analysis allows relevant and timely customer data to be identified and constructively used. Without sentiment analysis, identifying timely and relevant data may not be reliable. In addition, sentiment analysis allows for tailored and timely service that would not be available with only customer data analysis. In addition, sentiment analysis of a customer without associated customer data may not identify relevant customer data. For example, data that indicates a customer is happy may be useful, but combining the customer is happy with data that indicates that customer recently had an increase in multiple pay checks allows for tailored service that is not available with just sentiment analysis. Described herein are embodiments that combine both sentiment analysis of a customer with data associated with the customer to identify relevant and timely data. This data may be provided to the customer and/or provided to an employee that may help the customer.

As one example, sentiment analysis may be run on telephone conversations with customers at a call center. The sentiment analysis may provide an indication of frustration, anger, happiness, etc., for each of the customers. Relevant data associated with the customer, such as customer name, time of call, length of call, transcription of current call, recent website history of the customer, customer account information, etc., may be retrieved as well. The customer data and the sentiment data may be collected for multiple callers. Callers whose frustration/anger values reach a set threshold may be trigger a message to a supervisor. The supervisor may be provided with the sentiment analysis, a history of the sentiment analysis, and the customer data. The supervisor may then intercede in the phone call.

As another example, the supervisor may see the sentiment analysis and part of the customer data as part of an augmented reality system. For example, the manager may see the customer's name, length of call, purpose of the call, and an indication of the sentiment analysis. This information may be provided near the person taking the phone call. The manager may then select any of the customers to be provided with additional customer data. The manager may also select to join the call via the augmented realty system. As another example, the manager may be alerted based on the sentiment of callers. For examples, if any caller becomes angry or irate during a call, the manager may receive an alert.

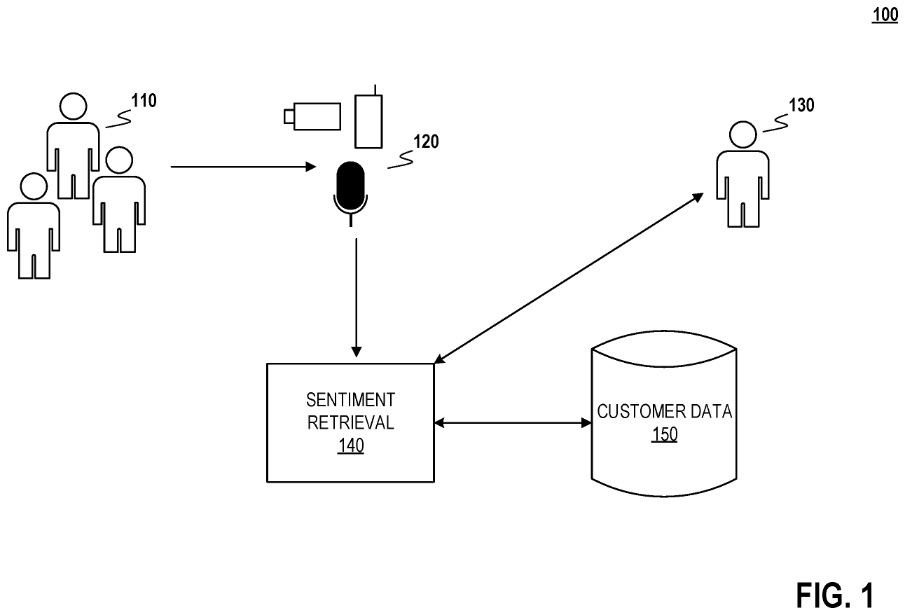

FIG. 1 is a block diagram showing a sentiment data retrieval system 100 according to some embodiments. The system 100 may be used in a variety of settings to provide relevant information about a customer or customers 110 to the customers 110 or to an employee 130 that may help the customer. The customers 110 may register and/or opt-in to the sentiment data retrieval system 100. During this registration, the customer 110 may provide approval and access to data related to the customer. For example, social media data, customer calendars, email, etc. In addition, the customer 110 may provide information such as a photograph that is used by a facial recognition system to identify the customer 110.

In one example, the system 110 may be installed at a physical location of a business. Input devices 120 capture real-time data associated with the customers 110. The data may be used to identify the customer 110. The input devices 120 may include cameras, microphones, eye scanner, etc. In addition, the input devices 120 may be a customer device, such as a mobile device that provides GPS data. In one example, an ATM machine may identify the customer 110 during a transaction by the customer 110.

Using data from the input devices 120, the customer 110 is recognized. For example, image or video data from a camera may be analyzed using facial recognition. Voice recognition may be done using audio recorded from a microphone. In addition, an application on a mobile device may provide a user identification that is used to identify the customer 110.

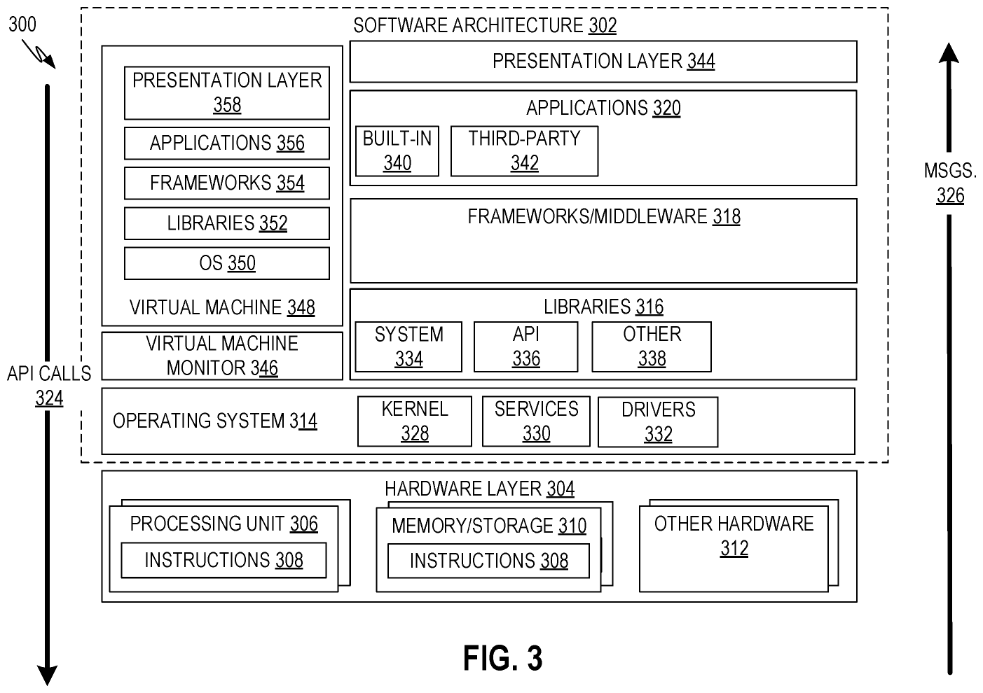

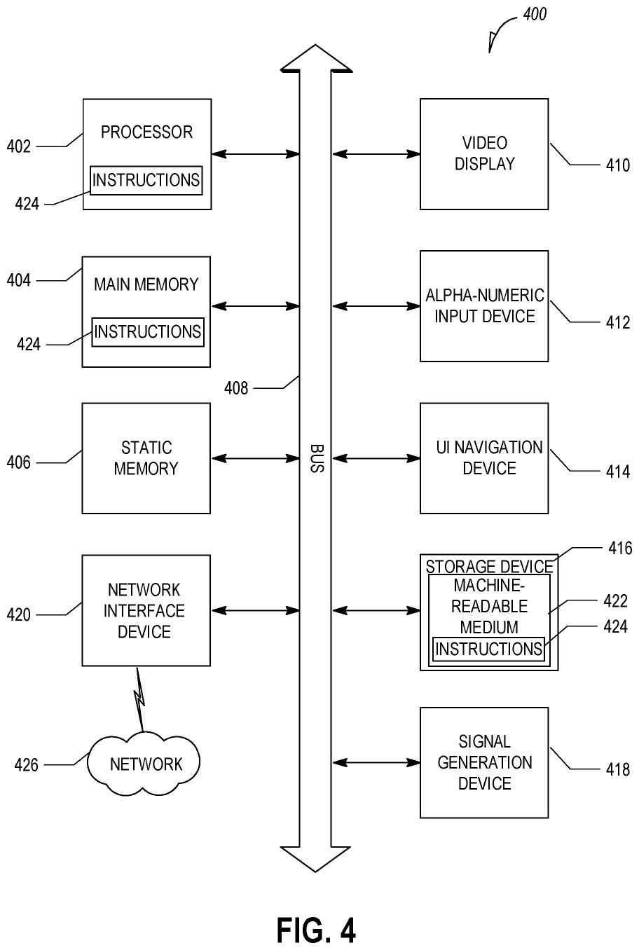

The data from the input devices 120 may be sent to a sentiment retrieval computing device 140. The sentiment retrieval computing device 140 may be implemented on the hardware architecture described below in FIG. 3 and FIG. 4. Accordingly, the structure of the sentiment retrieval computing device 140 is described in greater detail below in FIG. 3 and/or FIG. 4.

The sentiment retrieval computing device 140 may retrieve data from a customer data store 150 and provide to the customer 110 and/or to an employee 130. The sentiment retrieval computing device 140 or another computing component (not shown) may identify the customer using the data from the input devices 120. Once identified, customer data may be retrieved from the customer data store 150. Customer data may include account information, website history, customer history, etc. Based on the customer data, a customer relationship may be determined. For example, the customer may be identified as a banking customer, a frequent customer, a mortgage customer, etc.

The sentiment retrieval computing device 140 runs a sentiment analysis on the input data from the input devices 120. The sentiment analysis may include determining a level of happiness, frustration, anger, displeasure, etc. of the customer 110. The customer relationship and customer data combined with the sentiment analysis results are used to determine a customer need. For example, the customer need may be to deposit a check, ask a question about an account, etc. In one example, the customer data includes the customer's visits to the company's website. The visits may include the customer going to a frequently asked questions (FAQ) section within the last week concerning mortgages. In addition, the customer data may indicate that the customer recently called the company's telephone number and provide a transcript/call log of the call within the last week. The sentiment analysis may indicate that the customer 110 is agitated. The sentiment retrieval computing device 140 may determine the question has a question concerning a mortgage account.

The customer's visit to the FAQ web page, the telephone call transcript, and an indication that the customer is agitated may be provided to a bank teller 130. In addition, because the customer 110 is agitated, this information may be provided to a bank manager. In addition, the telephone call transcript may be analyzed to determine a question asked by the customer 110. The sentiment retrieval computing device 140 may then search for an answer. If found, the answer may be provided to the bank teller 130. In an example, the answer may also be provided to the customer 110 via the customer's mobile device.

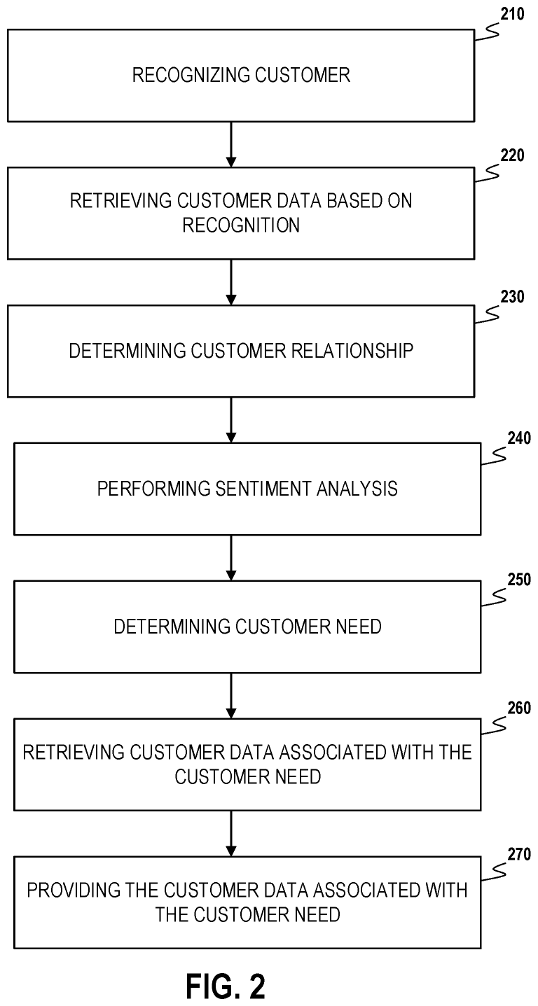

FIG. 2 is a flow diagram showing a process for retrieving data based on sentimental analysis according to some embodiments. The elements in FIG. 2 may be implemented on the software architecture described below in FIG. 3 and executed on computer hardware, such as the computer hardware in FIG. 4. In an example, prior to the process a customer my register to take advantage of the process. The registration process may include providing information such as a photograph to be used for facial recognition, a voice sample for voice recognition, and consent for such data to be collected. In addition, permission to access the customer's social media feed, calendar, etc., may also be provided by the customer. At 210, a customer is recognized. In an example, the customer is recognized using facial recognition, voice recognition, location information, or a combination of these. In an example, video data from video cameras is used as input to the facial recognition system. Audio from the video cameras or captured from another microphone may be input into a voice recognition system. In an example, the customer may also be identified using a customer identifier received from a customer's mobile device or from a transaction, such as an ATM transaction. Location information, such as GPS location, may also be used to confirm that a recognized customer is at a location. For example, a customer may be considered at a location when the customer is within the vicinity of the location. The vicinity of a location may be within 50, 100, 250 feet, etc., from the location. In one example, the location information may determine when the customer identifier is sent. For example, when a customer is near a location, such as a branch of a financial institution location, an application may detect the customer is near the location and then send the customer identifier.

At 220, customer data associated with the customer is retrieved. The customer data may include open accounts, account balances, listing of visits, locations of visits, recent transactions, recent phone calls, recent website visits, any issues raised, any questions asked or searched for by the customer, etc. At 230, this information is used to determine a customer relationship. For example, is the customer a high net worth customer, is the customer a new customer, is the customer a mortgage customer, etc. This information may be used to determine why the customer is visiting a location or a need of the customer.

Input data, such as a video feed, vocal feed, etc., is received. The input data may be the same data used to recognize the customer. The input data may be received from a video camera, a microphone, a telephone call, a chat history, etc. At 240, sentiment analysis is run on the input to determine a sentiment of the customer. In an example, the sentiment analysis provides a level for a variety of sentiments. For example, a customer may receive a score between 1 and 100 for a level of confusion, happiness, anger, frustration, etc.

In some examples, additional information associated with the customer may also be retrieved. For example, a customer's calendar may be accessed. The customer's calendar may indicate that a trip and/or vacation has recently been added. Social media accounts of the customer may also be accessed. For example, recent social media posts, likes, etc., may be retrieved. Recent data may include data from the last day, three days, week, month, year, etc. Additional information may also include news or weather that is local to the customer's residence or work. The information may be based on the resident location of the customer. For example, the city the customer lives in or news that is related to a location within the vicinity of the customer's residence may be used as the resident location to determine the additional information.

At 250, based on the sentiment analysis, the customer data, and the relationship with the customer, a customer need is determined. The additional information may also be used to determine a customer need. As an example, transaction history may indicate that a customer is likely to deposit a pay check or a bonus check based on a paycheck deposit history. The sentiment analysis may indicate that the user is happy and the social media information may indicate that the user recently received a promotion. Based on this information, the customer need may be determined to be depositing a check. Other customer needs may include making a withdrawal, wire money, creating a new account, a customer issue, making a payment, investing, a mortgage question, etc.

The customer need may also be determine using the customer's location. If the customer is home, at a branch, at work, moving, or a long way from home may all be used to determine the customer's need. For example, a customer that is traveling may be used to determine the customer needs information about exchange rates or branch locations.

The customer need may be determined using a computer learning algorithm. For example, historical customer data and sentimental data along with actual needs of the customer may be used to train a classifying system. Once trained, the classifying system may be used to determine a customer need. The additional information may be used to verify the determined customer need. In an example, the classifying system may provide two or three potential customer needs. The additional information may be used to change the ranking of the potential customer needs.

At 260, data associated with the determined need is retrieved. The retrieved data may be account information. As another example, the retrieved data may be information regarding a change in regulations related to the customer need. Compliance information may also be retrieved. For example, if the customer need is determined to be deposit a check or transfer funds, compliance information may be retrieved and provided. For example, a check for more than a certain amount of money may take longer to clear compared to a smaller check. This information may be retrieved.

At 270, the information is provided to an employee and/or directly to the customer. As an example, the determined need may be used to determine the most appropriate person to handle the customer's need. For example, a customer need may be determined to be to setup a new mortgage account based on the customer's savings goals and a happy sentiment. The retrieved data may include the types of possible mortgages and their benefits/costs. This information may be provided to the customer via the customer's mobile device. In addition, a potential new mortgage account alert may be directed to an employee that oversees opening new mortgage accounts rather than passed to a teller.

One example of using sentimental data retrieval is waiving a fee for an upset customer as part of a transaction. A customer may walk into a branch of a bank after having searched for fees related to a wire transfer using the bank. In addition, the customer may have used a chatbot to ask about how to wire money. After walking into the branch, the customer may become frustrated based on the length of a line of other customers. Based on retrieving the customer's recent web use and chat history, the perceived customer need may be to wire money. Using the customer's sentiment and the customer's need, the paperwork to complete for a wire transfer may be provided to the customer or the location of paper forms may be provided. In addition, a teller may be sent the customer's need and sentiment prior to the customer reaching the teller. In addition, knowing a customer is frustrated a welcome message may be sent to the customer's mobile device or a robot greeter may greet the customer.

During the transaction, the audio between the customer and the teller may be captured. A second sentiment analysis may be run on the captured audio. A level of displeasure may be determined as part of the second sentiment analysis. The level of displeasure may include a level of frustration, anger, confusion, etc. Based on the level of displeasure as well as the customer's past activity, the sentiment retrieval computing device may determine that the wire transfer fee may be reduced or waived. The sentiment retrieval computing device may automatically credit or eliminate the wire transfer fee. In addition, the teller helping the customer may be provided with an indication that the wire transfer fee is being reduced or waived. This information may be provided to the customer directly via the customer's mobile device. Additional information, such as the fee waiver policy may be provided to the teller and/or customer. In examples, where there is an audio recording of a transaction, a summary of the transaction may be created from the audio recording and provided to the customer. The audio recording may be done using a recording device, such as a microphone. The microphone may be incorporated into a mobile device.

Another example of using sentimental data retrieval is routing a call or a chat. For example. a telephone call with a customer may be recorded using a recording device. The sentiment analysis may be run continuously or at various times during the call to monitor the customer's sentiment. Based on the sentiment analysis, the call may be routed to a manager. For example, if the customer's sentiment continues to trend in a negative direction and passes a predetermined threshold, an audio that indicates the call is being transferred to a manger may be played and then the call may be transferred. Data regarding customers sentiments over many calls may be stored. This information may be used to indicate which employees handle upset customers well. For example, employees that increase an upset customer's sentiment in a positive direction may be identified. These employees may then be routed customer's that are initially determined to be upset or become upset during a call with another employee or an automated system.

Sentiment analysis may also be used to control a local environment. In the banking example, there may be a long line of customers within a branch where some customers are upset. The local environment within the branch may be controlled and changed based on the sentiment analysis of the customers. The lighting may be dimmed, music volume may be changed, or the music may change to more soothing music based on the sentiment analysis. The described system may also be used to detect a robbery. If the sentiment analysis shows a sudden spike in customers and/or employees being alarmed, scared, etc., a robbery event may be detected. If audio is being recorded, audio may also be combined with the sentiment analysis to further determine a robbery is in progress. If a robbery is detect an alert may be sent to a bank manager and/or authorities.

FIG. 3 is a block diagram 300 showing one example of a software architecture 302 for a computing device. The architecture 302 may be used in conjunction with various hardware architectures, for example, as described herein. The software architecture 302 may be used to implement retrieving data based on sentimental analysis described in FIG. 2. FIG. 3 is merely a non-limiting example of a software architecture 302 and many other architectures may be implemented to facilitate the functionality described herein. A representative hardware layer 304 is illustrated and can represent, for example, any of the above referenced computing devices. In some examples, the hardware layer 304 may be implemented according to the architecture 302 of FIG. 3.

The representative hardware layer 304 comprises one or more processing units 306 having associated executable instructions 308. The hardware layer 304 may be used to implement the sentiment retrieval 140 described in FIG. 1. Executable instructions 308 represent the executable instructions of the software architecture 302, including implementation of the methods, modules, components, and so forth of FIGS. 1-2. Hardware layer 304 also includes memory and/or storage modules 310, which also have executable instructions 308. Hardware layer 304 may also comprise other hardware as indicated by other hardware 312 which represents any other hardware of the hardware layer 304, such as the other hardware illustrated as part of hardware architecture 400.

In the example architecture of FIG. 3, the software 302 may be conceptualized as a stack of layers where each layer provides particular functionality. For example, the software 302 may include layers such as an operating system 314, libraries 316, frameworks/middleware 318, applications 320 and presentation layer 344. Operationally, the applications 320 and/or other components within the layers may invoke application programming interface (API) calls 324 through the software stack and receive a response, returned values, and so forth illustrated as messages 326 in response to the API calls 324. The layers illustrated are representative in nature and not all software architectures have all layers. For example, some mobile or special purpose operating systems may not provide a frameworks/middleware layer 318, while others may provide such a layer. Other software architectures may include additional or different layers.

The operating system 314 may manage hardware resources and provide common services. The operating system 314 may include, for example, a kernel 328, services 330, and drivers 332. The kernel 328 may act as an abstraction layer between the hardware and the other software layers. For example, the kernel 328 may be responsible for memory management, processor management (e.g., scheduling), component management, networking, security settings, and so on. The services 330 may provide other common services for the other software layers. In some examples, the services 330 include an interrupt service. The interrupt service may detect the receipt of a hardware or software interrupt and, in response, cause the architecture 302 to pause its current processing and execute an interrupt service routine (ISR) when an interrupt is received. The ISR may generate the alert, for example, as described herein.

The drivers 332 may be responsible for controlling or interfacing with the underlying hardware. For instance, the drivers 332 may include display drivers, camera drivers, Bluetooth® drivers, flash memory drivers, serial communication drivers (e.g., Universal Serial Bus (USB) drivers), Wi-Fi® drivers, NFC drivers, audio drivers, power management drivers, and so forth depending on the hardware configuration.

The libraries 316 may provide a common infrastructure that may be utilized by the applications 320 and/or other components and/or layers. The libraries 316 typically provide functionality that allows other software modules to perform tasks in an easier fashion than to interface directly with the underlying operating system 314 functionality (e.g., kernel 328, services 330 and/or drivers 332). The libraries 316 may include system 334 libraries (e.g., C standard library) that may provide functions such as memory allocation functions, string manipulation functions, mathematic functions, and the like. In addition, the libraries 316 may include API libraries 336 such as media libraries (e.g., libraries to support presentation and manipulation of various media format such as MPEG4, H.264, MP3, AAC, AMR, JPG, PNG), graphics libraries (e.g., an OpenGL framework that may be used to render 2D and 9D in a graphic content on a display), database libraries (e.g., SQLite that may provide various relational database functions), web libraries (e.g., WebKit that may provide web browsing functionality), and the like.

The libraries 316 may also include a wide variety of other libraries 338 to provide many other APIs to the applications 320 and other software components/modules.

The frameworks 318 (also sometimes referred to as middleware) may provide a higher-level common infrastructure that may be utilized by the applications 320 and/or other software components/modules. For example, the frameworks 318 may provide various graphic user interface (GUI) functions, high-level resource management, high-level location services, and so forth. The frameworks 318 may provide a broad spectrum of other APIs that may be utilized by the applications 320 and/or other software components/modules, some of which may be specific to a particular operating system or platform.

The applications 320 includes built-in applications 340 and/or third-party applications 342. Examples of representative built-in applications 340 may include, but are not limited to, a contacts application, a browser application, a book reader application, a location application, a media application, a messaging application, and/or a game application. Third-party applications 342 may include any of the built in applications as well as a broad assortment of other applications. In a specific example, the third-party application 342 (e.g., an application developed using the Android™ or iOS™ software development kit (SDK) by an entity other than the vendor of the particular platform) may be mobile software running on a mobile operating system such as iOS™, Android™, Windows® Phone, or other mobile computing device operating systems. In this example, the third-party application 342 may invoke the API calls 324 provided by the mobile operating system such as operating system 314 to facilitate functionality described herein.

The applications 320 may utilize built in operating system functions (e.g., kernel 328, services 330 and/or drivers 332), libraries (e.g., system 334, APIs 336, and other libraries 338), frameworks/middleware 318 to create user interfaces to interact with users of the system. Alternatively, or additionally, in some systems interactions with a user may occur through a presentation layer, such as presentation layer 344. In these systems, the application/module “logic” can be separated from the aspects of the application/module that interact with a user.

Some software architectures utilize virtual machines. For example, systems described herein may be executed utilizing one or more virtual machines executed at one or more server computing machines. In the example of FIG. 3, this is illustrated by virtual machine 348. A virtual machine creates a software environment where applications/modules can execute as if they were executing on a hardware computing device. A virtual machine is hosted by a host operating system (operating system 314) and typically, although not always, has a virtual machine monitor 346, which manages the operation of the virtual machine as well as the interface with the host operating system (i.e., operating system 314). A software architecture executes within the virtual machine such as an operating system 350, libraries 352, frameworks/middleware 354, applications 356 and/or presentation layer 358. These layers of software architecture executing within the virtual machine 348 can be the same as corresponding layers previously described or may be different.

The architecture 400 may operate as a standalone device or may be connected (e.g., networked) to other machines. In a networked deployment, the architecture 400 may operate in the capacity of either a server or a client machine in server-client network environments, or it may act as a peer machine in peer-to-peer (or distributed) network environments. The architecture 400 can be implemented in a personal computer (PC), a tablet PC, a hybrid tablet, a set-top box (STB), a personal digital assistant (PDA), a mobile telephone, a web appliance, a network router, switch or bridge, or any machine capable of executing instructions (sequential or otherwise) that specify operations to be taken by that machine.

Example architecture 400 includes a processor unit 402 comprising at least one processor (e.g., a central processing unit (CPU), a graphics processing unit (GPU) or both, processor cores, compute nodes, etc.). The architecture 400 may further comprise a main memory 404 and a static memory 406, which communicate with each other via a link 408 (e.g., bus). The architecture 400 can further include a video display unit 410, an alphanumeric input device 412 (e.g., a keyboard), and a user interface (UI) navigation device 414 (e.g., a mouse). In some examples, the video display unit 410, input device 412 and UI navigation device 414 are incorporated into a touch screen display. The architecture 400 may additionally include a storage device 416 (e.g., a drive unit), a signal generation device 418 (e.g., a speaker), a network interface device 420, and one or more sensors (not shown), such as a global positioning system (GPS) sensor, compass, accelerometer, or other sensor.

In some examples, the processor unit 402 or other suitable hardware component may support a hardware interrupt. In response to a hardware interrupt, the processor unit 402 may pause its processing and execute an interrupt service routine (ISR), for example, as described herein.

The storage device 416 includes a machine-readable medium 422 on which is stored one or more sets of data structures and instructions 424 (e.g., software) embodying or utilized by any one or more of the methodologies or functions described herein. The instructions 424 can also reside, completely or at least partially, within the main memory 404, static memory 406, and/or within the processor 402 during execution thereof by the architecture 400, with the main memory 404, static memory 406, and the processor 402 also constituting machine-readable media. Instructions stored at the machine-readable medium 422 may include, for example, instructions for implementing the software architecture 400, instructions for executing any of the features described herein, etc.

While the machine-readable medium 422 is illustrated in an example to be a single medium, the term “machine-readable medium” can include a single medium or multiple media (e.g., a centralized or distributed database, and/or associated caches and servers) that store the one or more instructions 424. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including, but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

The instructions 424 can further be transmitted or received over a communications network 426 using a transmission medium via the network interface device 420 utilizing any one of a number of well-known transfer protocols (e.g., HTTP). Examples of communication networks include a local area network (LAN), a wide area network (WAN), the Internet, mobile telephone networks, plain old telephone (POTS) networks, and wireless data networks (e.g., Wi-Fi, 3G, and 6G LTE/LTE-A or WiMAX networks). The term “transmission medium” shall be taken to include any intangible medium that is capable of storing, encoding, or carrying instructions for execution by the machine, and includes digital or analog communications signals or other intangible medium to facilitate communication of such software.

Various components are described in the present disclosure as being configured in a particular way. A component may be configured in any suitable manner. For example, a component that is or that includes a computing device may be configured with suitable software instructions that program the computing device. A component may also be configured by virtue of its hardware arrangement or in any other suitable manner.

The above description is intended to be illustrative, and not restrictive. For example, the above-described examples (or one or more aspects thereof) can be used in combination with others. Other embodiments can be used, such as by one of ordinary skill in the art upon reviewing the above description. The Abstract is to allow the reader to quickly ascertain the nature of the technical disclosure, for example, to comply with 37 C.F.R. § 1.72(b) in the United States of America. It is submitted with the understanding that it will not be used to interpret or limit the scope or meaning of the claims.

Also, in the above Detailed Description, various features can be grouped together to streamline the disclosure. However, the claims cannot set forth every feature disclosed herein as embodiments can feature a subset of said features. Further, embodiments can include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A method comprising operations performed using an electronic processor unit, the operations comprising:
receiving, from a mobile device, a customer identifier, wherein the customer identifier is received based on the mobile device being located within a vicinity of a branch of a financial institution;
capturing image data of a customer;
providing the image data to a facial recognition system;
performing facial recognition on the image data;
recognizing a customer based on the facial recognition;
retrieving customer data associated with the customer based on the recognizing the customer;
determining a relationship with the customer based on the customer data;
retrieving sentiment data;
retrieving additional information associated with the customer from one of a social media account associated with the customer or a calendar associated with the customer;
retrieving a transaction history of the customer;
analyzing and scoring the sentiment data to determine a sentiment;
determining that the sentiment exceeds a predetermined threshold; and
determining a need of the customer based on the relationship with the customer, the sentiment, the additional information associated with the customer, and the transactions history.

2. (canceled)

3. (canceled)

4. The method of claim 1, further comprising:
capturing, using a recording device during a transaction between the customer and an employee, audio of the customer; and
running a second sentiment analysis on the audio.

5. (canceled)

6. (canceled)

7. The method of claim 4, further comprising:
summarizing the transaction based on the captured audio; and
providing the summary to the customer.

8. The method of claim 1, further comprising determining a resident location of the customer, wherein the customer data is associated with the resident location.

9. (canceled)

10. The method of claim 1, wherein the customer data comprises interactions with website content associated with a transaction.

11. The method of claim 10, further comprising running a second sentiment analysis on the voice data.

12. (canceled)

13. A system comprising:
an electronic processor configured to:
receive, from a mobile device, a customer identifier, wherein the customer identifier is received based on the mobile device being located within a vicinity of a branch of a financial institution;
capture image data of a customer;
provide the image data to a facial recognition system:
perform facial recognition on the image data,
recognize a customer based on the facial recognition;
retrieve customer data associated with the customer based on the recognizing the customer;
determine a relationship with the customer based on the customer data;
retrieving sentiment data:
retrieve additional information associated with the customer from one of a social media account associated with the customer or a calendar associated with the customer;
retrieve a transaction history of the customer;
analyze and score the sentiment data to determine a sentiment;
determine that the sentiment exceeds a predetermined threshold: and
determine a need of the customer based on the relationship with the customer, the sentiment, the additional information associated with the customer, and the transaction history.

14. (canceled)

15. (canceled)

16. The system of claim 13, wherein the electronic processor is further configured to:
capture, using a recording device during a transaction between the customer and an employee, audio of the customer; and
run a second sentiment analysis on the audio.

17. (canceled)

18. A non-transitory machine-readable medium comprising instructions thereon that, when executed by at least one processor unit, causes the at least one processor unit to perform operations comprising:
receiving, from a mobile device, a customer identifier, wherein the customer identifier is received based on the mobile device being located within a vicinity of a branch of a financial institution;
capturing image data of a customer;
providing the image data to a facial recognition system;
performing facial recognition on the image data;
recognizing a customer based on the facial recognition;
retrieving customer data associated with the customer based on the recognizing the customer;
determining a relationship with the customer based on the customer data;
retrieving sentiment data;
retrieving additional information associated with the customer from one of a social media account associated with the customer or a calendar associated with the customer;
retrieving a transaction history of the customer;
analyzing and scoring the sentiment data to determine a sentiment;
determining that the sentiment exceeds a predetermined threshold; and
determining a need of the customer based on the relationship with the customer, the sentiment, the additional information associated with the customer, and the transaction history.

19. (canceled)

20. (canceled)

21. The method of claim 1, wherein the call is between the mobile device and an entity associated with the financial institution.

22. The system of claim 13 wherein the call is between the mobile device and an entity associated with the financial institution.

23. The non-transitory machine-readable medium of claim 18, wherein the call is between the mobile device and an entity associated with the financial institution.
